(19) United States
(12) Patent Application Publication
(10) Pub. No.: US 2018/0208079 A1
(43) Pub. Date: Jul. 26, 2018

(54) SYSTEM AND METHOD FOR PROTECTING HIGH-VOLTAGE COMPONENTS

(71) Applicant: FORD GLOBAL TECHNOLOGIES, LLC, Dearborn, MI (US)

(72) Inventors: Jukkrit NOPPAKUNKAJORN, Canton, MI (US); Kevin Lloyd NEWMAN, Farmington Hills, MI (US)

(21) Appl. No.: 15/416,369

(22) Filed: Jan. 26, 2017

(51) Int. Cl. B60L 15/20; B60L 11/18

(52) U.S. Cl. CPC B60L 15/2045; Y10S 903/907; B60L 2210/10; B60L 11/1814

(57) ABSTRACT

A power distribution system for a vehicle includes a first contactor configured to selectively couple a traction battery and an inverter that operates an electric machine via switch control. The system includes a second contactor that selectively couples an electrical load and the traction battery. The first contactor and the second contactor are closed to operate the vehicle. The system includes a controller programmed to, in response to loss of the inverter switching control, open the first contactor but not the second contactor to isolate the inverter from the traction battery.

### TECHNICAL FIELD

This application generally relates to controlling contactors between a traction battery and high-voltage electrical components in a vehicle.

### BACKGROUND

Electrified vehicles include high-voltage components that are connected to a high-voltage bus. Some vehicles include a variable voltage converter (VVC) connected between the high-voltage bus and an inverter that controls an electric machine. The VVC can be operated to boost an output voltage to provide the voltage for the electric machine. In addition, the VVC can be operated to transfer energy from the inverter to the high-voltage bus. For example, power may be generated by the electric machine and transferred to the high-voltage bus. The VVC can be controlled to regulate the voltage and current provided to the high-voltage bus to ensure that operating voltage limits of the high-voltage components are not violated. In vehicles that do not include a VVC, techniques for managing the voltage generated by the electric machine are limited to control of the inverter.

### SUMMARY

A vehicle includes a first contactor selectively coupling a traction battery and an inverter that operates an electric machine via switch control. The vehicle further includes a second contactor selectively coupling an electrical load and the traction battery, the first contactor and the second contactor being closed during the switch control. The vehicle further includes a controller programmed to, in response to loss of the switch control, open the first contactor but not the second contactor to isolate the inverter.

A power distribution system for a vehicle includes a first contactor selectively coupling a traction battery and an inverter that operates an electric machine via switch control. The power distribution system further includes a second contactor selectively coupling an electrical load and the traction battery. The power distribution system further includes a controller programmed to, in response to loss of the switch control, open the first contactor but not the second contactor to isolate the inverter.

A method includes closing, by a controller, a first contactor coupling a traction battery to an inverter that controls an electric machine via switch control and a second contactor coupling the traction battery to an electrical load for operating a vehicle. The method further includes opening, by the controller, the first contactor in response to loss of the switch control. The method further includes maintaining, by the controller, the second contactor as closed during loss of the switch control.

### BRIEF DESCRIPTION OF THE DRAWINGS

FIG. 1 depicts a possible configuration for an electrified vehicle.

FIG. 2 depicts a possible configuration for contactors in a high-voltage system.

FIG. 3 depicts a flowchart for a possible sequence of operation for controlling the contactors of the high-voltage system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

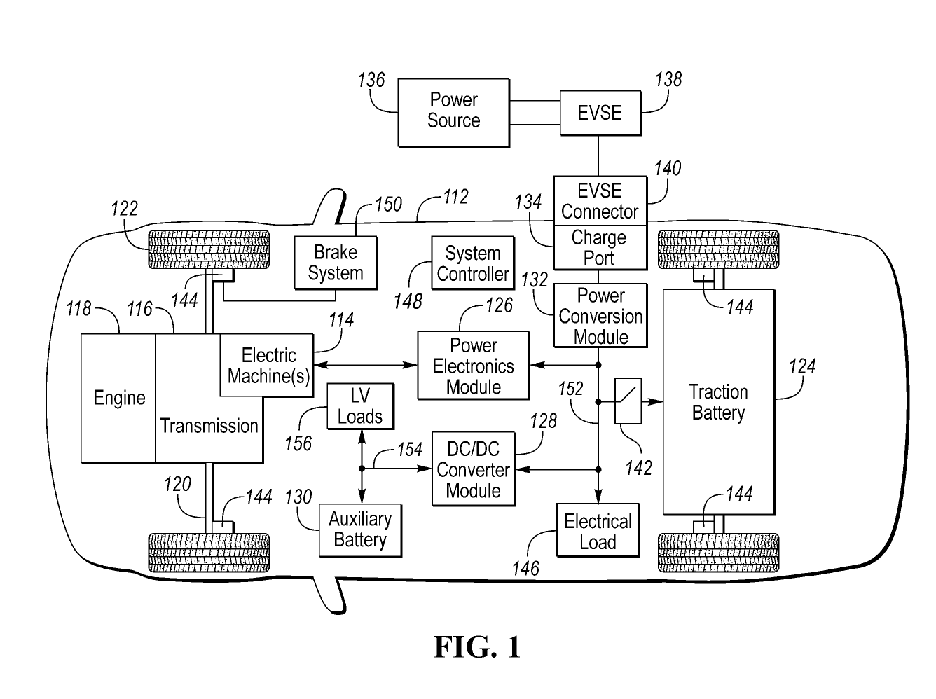

FIG. 1 depicts an electrified vehicle 112 that may be referred to as a plug-in hybrid-electric vehicle (PHEV). A plug-in hybrid-electric vehicle 112 may comprise one or more electric machines 114 mechanically coupled to a gearbox or hybrid transmission 116. The electric machines 114 may be capable of operating as a motor and a generator. In addition, the hybrid transmission 116 is mechanically coupled to an engine 118. The hybrid transmission 116 is also mechanically coupled to a drive shaft 120 that is mechanically coupled to the wheels 122. The electric machines 114 can provide propulsion and deceleration capability when the engine 118 is turned on or off. The electric machines 114 may also act as generators and can provide fuel economy benefits by recovering energy that would normally be lost as heat in a friction braking system. The electric machines 114 may also reduce vehicle emissions by allowing the engine 118 to operate at more efficient speeds and allowing the hybrid-electric vehicle 112 to be operated in electric mode with the engine 118 off under certain conditions. An electrified vehicle 112 may also be a battery electric vehicle (BEV). In a BEV configuration, the engine 118 may not be present. In other configurations, the electrified vehicle 112 may be a full hybrid-electric vehicle (FHEV) without plug-in capability.

A battery pack or traction battery 124 stores energy that can be used by the electric machines 114. The traction battery 124 may provide a high voltage direct current (DC) output. A contactor module 142 may include one or more contactors configured to isolate the traction battery 124 from a high-voltage bus 152 when opened and connect the traction battery 124 to the high-voltage bus 152 when closed. The high-voltage bus 152 may include power and return conductors for carrying current over the high-voltage bus 152. The contactor module 142 may be located in the traction battery 124. One or more power electronics modules 126 (also known as an inverter) may be electrically coupled to the high-voltage bus 152. The power electronics modules 126 are also electrically coupled to the electric machines 114 and provide the ability to bi-directionally transfer energy between the traction battery 124 and the electric machines 114. For example, a traction battery 124 may provide a DC voltage while the electric machines 114 may operate with a three-phase alternating current (AC) to function. The power electronics module 126 may convert the DC voltage to a three-phase AC current to operate the electric machines 114. In a regenerative mode, the power electronics module 126 may convert the three-phase AC current from the electric machines 114 acting as generators to the DC voltage compatible with the traction battery 124.

In addition to providing energy for propulsion, the traction battery 124 may provide energy for other vehicle electrical systems. The vehicle 112 may include a DC/DC converter module 128 that converts the high voltage DC output from the high-voltage bus 152 to a low-voltage DC level of a low-voltage bus 154 that is compatible with low-voltage loads 156. An output of the DC/DC converter module 128 may be electrically coupled to an auxiliary battery 130 (e.g., 12V battery) for charging the auxiliary battery 130. The low-voltage loads 156 may be electrically coupled to the auxiliary battery 130 via the low-voltage bus 154. One or more high-voltage electrical loads 146 may be coupled to the high-voltage bus 152. The high-voltage electrical loads 146 may have an associated controller that operates and controls the high-voltage electrical loads 146 when appropriate. Examples of high-voltage electrical loads 146 may be a fan, an electric heating element and/or an air-conditioning compressor.

The electrified vehicle 112 may be configured to recharge the traction battery 124 from an external power source 136. The external power source 136 may be a connection to an electrical outlet. The external power source 136 may be electrically coupled to a charge station or electric vehicle supply equipment (EVSE) 138. The external power source 136 may be an electrical power distribution network or grid as provided by an electric utility company. The EVSE 138 may provide circuitry and controls to regulate and manage the transfer of energy between the power source 136 and the vehicle 112. The external power source 136 may provide DC or AC electric power to the EVSE 138. The EVSE 138 may have a charge connector 140 for coupling to a charge port 134 of the vehicle 112. The charge port 134 may be any type of port configured to transfer power from the EVSE 138 to the vehicle 112. The charge port 134 may be electrically coupled to an on-board power conversion module or charger 132. The charger 132 may condition the power supplied from the EVSE 138 to provide the proper voltage and current levels to the traction battery 124 and the high-voltage bus 152. The charger 132 may interface with the EVSE 138 to coordinate the delivery of power to the vehicle 112. The EVSE connector 140 may have pins that mate with corresponding recesses of the charge port 134. Alternatively, various components described as being electrically coupled or connected may transfer power using a wireless inductive coupling.

One or more wheel brakes 144 may be provided for decelerating the vehicle 112 and preventing motion of the vehicle 112. The wheel brakes 144 may be hydraulically actuated, electrically actuated, or some combination thereof. The wheel brakes 144 may be a part of a brake system 150. The brake system 150 may include other components to operate the wheel brakes 144. For simplicity, the figure depicts a single connection between the brake system 150 and one of the wheel brakes 144. A connection between the brake system 150 and the other wheel brakes 144 is implied. The brake system 150 may include a controller to monitor and coordinate the brake system 150. The brake system 150 may monitor the brake components and control the wheel brakes 144 for vehicle deceleration. The brake system 150 may respond to driver commands and may also operate autonomously to implement features such as stability control. The controller of the brake system 150 may implement a method of applying a requested brake force when requested by another controller or sub-function.

Electronic modules in the vehicle 112 may communicate via one or more vehicle networks. The vehicle network may include a plurality of channels for communication. One channel of the vehicle network may be a serial bus such as a Controller Area Network (CAN). One of the channels of the vehicle network may include an Ethernet network defined by Institute of Electrical and Electronics Engineers (IEEE) 802 family of standards. Additional channels of the vehicle network may include discrete connections between modules and may include power signals from the auxiliary battery 130. Different signals may be transferred over different channels of the vehicle network. For example, video signals may be transferred over a high-speed channel (e.g., Ethernet) while control signals may be transferred over CAN or discrete signals. The vehicle network may include any hardware and software components that aid in transferring signals and data between modules. The vehicle network is not shown in FIG. 1 but it may be implied that the vehicle network may connect to any electronic modules that are present in the vehicle 112. A vehicle system controller (VSC) 148 may be present to coordinate the operation of the various components.

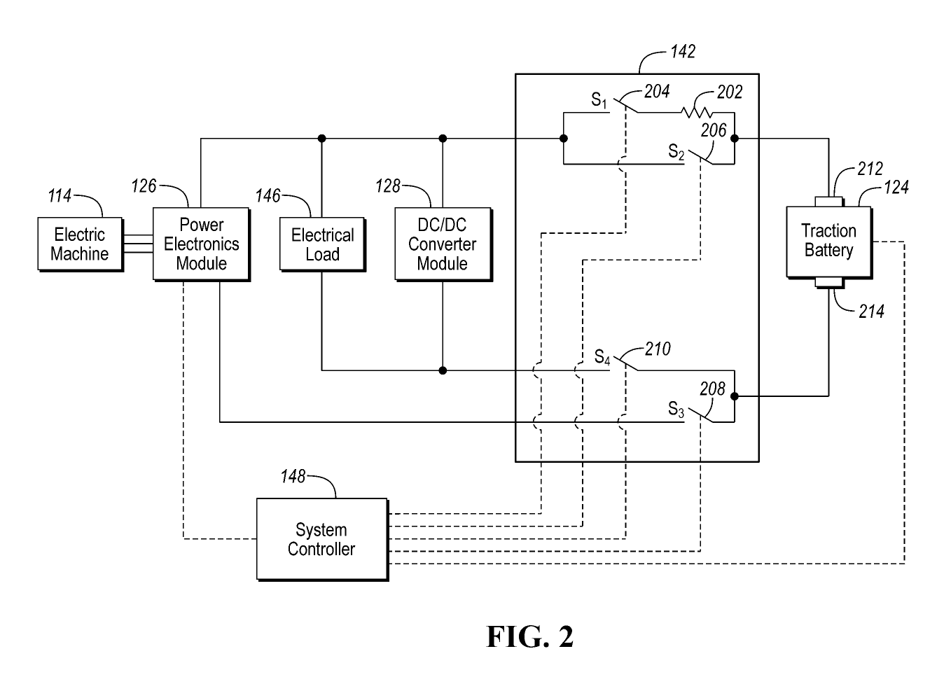

FIG. 2 depicts a configuration of a high-voltage power distribution system for a vehicle including a plurality of contactors. The contactor module 142 may include a pre-charge contactor 204 (S1) that is electrically coupled in series with a pre-charge resistor 202. The pre-charge resistor 202 may limit the current flowing through the high-voltage bus 152 during startup when the traction battery 124 is initially connected to the high-voltage bus 152. The contactor module 142 may include a main contactor 206 (S2) that is configured to selectively electrically couple a positive terminal 212 of the traction battery 124 to a positive-side of the high-voltage bus 152. The contactor module 142 may include an inverter return contactor 208 (S3) that is configured to selectively electrically couple a traction battery return terminal 214 (return terminal of the traction battery 124) to an inverter return terminal (return side of the power electronics module 126). The contactor module 142 may include a high-voltage return contactor 210 (S4) that is configured to selectively electrically couple the traction battery return terminal 214 to an electrical load return (return side of other high-voltage components such as the electrical load 146 and the DC/DC converter module 128).

The contactors 204, 206, 208, 210 may be electromagnetic switches such as a relay. The contactor may include a coil which opens or closes an associated switch when energized. For example, the contactors may be normally-open contactors such that the switch is opened when the coil is de-energized and closed when the coil is energized. A coil may be energized by applying a voltage across the coil to cause current to flow in the coil. The coils may be electrically coupled to a controller 148 that is configured to provide voltage and current to the coils. In some configurations, the contactors may be solid-state devices such as an Insulated Gate Bipolar Transistor (IGBT) or similar device. A controller (e.g., system controller 148) may be configured to drive the coils using hardware components and software functions.

Electrical components (such as electrical load 146 and DC/DC converter module 128) that are connected to the high-voltage bus 152 may have voltage and/or power limits at the associated input terminals of the components. Exceeding these limits may result in a loss of function of the component. Electrical components may be designed with input limits that exceed a maximum voltage or power level that may be expected to be applied at the input. The maximum voltage or power level may be greater than the nominal operating power and voltage levels of the component. This may lead to components being designed to withstand conditions that rarely occur during vehicle operation.

Voltage and power levels on the high-voltage bus 152 may be affected by any components that can provide power to the high-voltage bus 152. That is, components that can cause a voltage that is greater than the traction battery voltage. For example, during some conditions, the regenerative power may exceed the battery limits and may cause the battery contactors to be opened. The power electronics module 126 may cause the bus voltage to increase during regenerative braking when the electric machine 114 operates as a generator. During normal regenerative braking conditions, the power electronics module 126 controls the current/power that is provided to the high-voltage bus 152.

The electric machine 114 may be a permanent magnet (PM) machine in which magnets are disposed in a rotor of the electric machine 114. Rotation of the rotor may induce a voltage in phase windings of the electric machine 114. The electric machine 114 operating as a generator creates a voltage called a back electromotive force (EMF) when rotating. When the power electronics module 126 is functioning as designed, the power electronics module 126 is operated to control the voltage and power level supplied to the high-voltage bus 152. However, under some conditions, the power electronics module 126 may be unable to control the voltage level.

The power electronics module 126 may be configured to switch positive and negative terminals of the high-voltage bus 152 to phase terminals of the electric machine 114. The power electronics module 126 may interface with a position or speed feedback device that is coupled to the rotor of the electric machine 114. For example, the speed feedback device may be a resolver or an encoder. The speed feedback device may provide signals indicative of a position and/or speed of the rotor of the electric machine 114. The power electronics module 126 may include a power electronics controller (not shown) that interfaces to the speed feedback device and processes signals from the speed feedback device. The power electronics controller may be programmed to utilize the speed and position feedback to control operation of the electric machine 114.

The power electronics module 126 may include a plurality of switching devices. The switching devices may be Insulated Gate Bipolar Junction Transistors (IGBTs) or other solid-state switching devices. The switching devices may be configured to selectively couple a positive terminal and a negative terminal of the high-voltage bus 152 to each phase terminal or leg (e.g., sometimes referred to as U, V, and W phases) of the electric machine 114. Each of the switching devices may have an associated diode connected in parallel to provide a path for inductive current when the switching device is in a non-conducting state. Each of the switching devices may have a control terminal for controlling operation of the associated switching device. The control terminals may be electrically coupled to the power electronics controller. The power electronics controller may include associated circuitry to drive and monitor the control terminals.

A first switching device may selectively couple the positive terminal of the high-voltage bus 152 to a first phase terminal (e.g., phase U) of the electric machine 114. A first diode may be coupled in parallel to the first switching device. The first diode may be arranged such that current flow from the positive terminal to the first phase terminal is blocked when the first switching device is deactivated. A second switching device may selectively couple the negative terminal of the high-voltage bus 152 to the first phase terminal (e.g., phase U) of the electric machine 114. A second diode may be coupled in parallel to the second switching device. The second diode may be arranged such that current flow from the first phase terminal to the negative terminal is blocked when the second switching device is deactivated. The same configuration of switching devices and diodes may be present for each phase terminal (e.g., V phase and W phase) of the electric machine 114.

The power electronics controller may be programmed to operate the switching devices to control the voltage and current applied to the electric machine 114. The power electronics controller may implement a switch control strategy to operate the switching devices for controlling operation of the electric machine 114. The power electronics controller may operate the switching devices so that each phase terminal is coupled to only one of the positive terminal or the negative terminal of the high-voltage bus 152 at a particular time. Various motor control algorithms and switch control strategies are available to be implemented in the power electronics controller. The power electronics module 126 may also include current sensors and voltage sensors. Current sensors may be inductive or Hall-effect devices configured to generate a signal indicative of the current passing through the associated circuit. Voltage sensors may be resistive networks and include isolation to separate high voltages from the low-voltage system.

Under normal operating conditions, the power electronics controller controls operation of the electric machine 114. For example, in response to torque and/or speed setpoints, the power electronics controller may operate the switching devices to control the torque and speed of the electric machine 114 to achieve the setpoints. The torque and/or speed setpoints may be processed to generate a desired switching pattern for the switching devices. The control terminals of the switching devices may be driven with Pulse Width Modulated (PWM) signals to control the torque and speed of the electric machine 114. The power electronics controller may implement various well-known switch control strategies to control the electric machine 114 using the switching devices such as vector control and six-step control. During normal operating conditions, the switching devices are actively controlled to achieve a desired current through each phase of the electric machine 114.

Under some conditions, the power electronics controller may experience a loss of the switch control. That is, the power electronics controller is unable to operate the switching devices for some reason. In this condition, the switching devices are in a non-conducting state. Under these conditions, the electric machine 114 is unable to be used for propulsion. However, the diodes may allow current to flow from the electric machine 114 to the high-voltage bus 152 in a non-controlled manner.

The loss of switch control may be detected in response to a temperature of the power electronics module 126 exceeding a predetermined threshold. For example, when a temperature limit of the switching devices is exceeded, further operation may degrade the switching devices. When the temperature exceeds the threshold, the power electronics module 126 may inhibit operation of the switching devices to protect the switching devices. The loss of switch control may also be detected in response to a loss of low-voltage power to the power electronics module 126. In this condition, the power electronics controller may not be operating. The power electronics module 126 may detect this condition when a voltage of a low-voltage power source that powers the power electronics module 126 is less than a predetermined threshold. In some cases, a loss of switching control may be detected upon a loss of communication between the system controller 148 and the power electronics module 126. Other internal fault conditions within the electronic module 126 may cause a loss of the switch control. For example, open or short circuits in the power electronics module 126 may cause a loss of the switch control. Various fault conditions of the power electronics module 126 may cause detection of the loss of switch control. Such fault conditions may be reported to the system controller 148 via the vehicle network.

The loss of the switch control inhibits the power electronics module 126 from controlling the back EMF of the electric machine 114. In order to control the voltage, the power electronics module 126 must be able to control switching devices that selectively couple the traction battery terminals to each of the phase windings of the electric machine 114. If any conditions are present that prevent the switch control strategy of the power electronics module 126 from controlling the switching devices, the back EMF may not be controllable. During conditions in which the power electronics module 126 cannot operate the switching devices, voltage generated by rotation of the electric machine 114 may cause current flow to the high-voltage bus 152 through the parallel diodes. When the switching elements of the power electronics module 126 cannot be controlled (e.g., loss of the switch control), the voltage caused by the back EMF cannot be controlled and the current flowing through the diodes cannot be modified by operation of the switching devices. Worst case back EMF voltage conditions may occur when the electric machine 114 is rotating at high speeds. Under some conditions, the back EMF could exceed operating limits of other components that are coupled to the high-voltage bus 152.

A possible solution for handling the increased voltage includes using a VVC (a bidirectional DC/DC converter) between the power electronics module 126 and the traction battery 124 and controlling the VVC to limit the bus voltage. Another possible solution may be to shift the transmission gear to reduce a speed of the electric machine 114 to reduce the regenerative voltage level. Another solution may include adjusting a speed of the engine to reduce the regenerative voltage level. Another solution may be disconnecting the electric machine 114 from the drivetrain to prevent rotation via one or more clutches. The issue may also be addressed by designing components coupled to the high-voltage bus 152 to be rated for the maximum back EMF of the electric machine 114. In some configurations, components (e.g., the VVC) that may be configured to prevent the back EMF issue may not be present in the vehicle. Addition of these components adds additional cost to the vehicle. The objective of any solution may be to prevent exposure of components coupled to the high-voltage bus 152 to high-voltage levels caused by uncontrolled back EMF of the electric machine 114.

Another solution to managing the bus voltage during a loss of the power electronics module switching control is by the operation of the inverter return contactor 208 (S3) and the high-voltage return contactor 210 (S4). When conditions are present in which there is a loss of switch control in the power electronics module 126 such that the voltage from the electric machine 114 cannot be controlled, the inverter return contactor 208 may be opened. The effect of this is to open the circuit that includes the power electronics module 126 and the high-voltage bus 152. As such, current will no longer flow between the power electronics module 126 and the high-voltage bus 152.

During this condition, the high-voltage return contactor 210 may be maintained in a closed state. As such, the electrical load 146 and the DC/DC converter module 128 may continue to be coupled to the traction battery 124. Since the power electronics module 126 is prevented from flowing current to the high-voltage bus 152, the electrical load 146 and the DC/DC converter module 128 are not subjected to excessive voltage levels. In addition, the electrical load 146 and the DC/DC converter module 128 may continue operating during this condition. A further benefit of this configuration is that components other than the power electronics module 126 may be designed to handle only the maximum traction battery voltage and not the maximum motor back EMF voltage. This may result in cost savings for electrical components that are coupled to the high-voltage bus 152.

If the switch control is restored (e.g., power electronics module 126 is again able to control the back EMF of the electric machine 114), the inverter return contactor 208 may be closed so that current may flow through the inverter circuit loop. A pre-charge operation may be performed when transitioning the inverter return contactor 208 to the closed state. For example, prior to closing the inverter return contactor 208, the main contactor 206 may be opened and the pre-charge contactor 204 may be closed. In some cases, the pre-charge contactor 204 may be closed before opening the main contactor 206 to allow continued operation of the electrical load 146 and the DC/DC converter module 128. When the inverter return contactor 208 is then closed, current may flow through the pre-charge resistor 202 to limit current flow to the power electronics module 126 until capacitive elements are charged. Once the capacitive elements are charged, the main contactor 206 may be closed and the pre-charge contactor 204 may be opened.

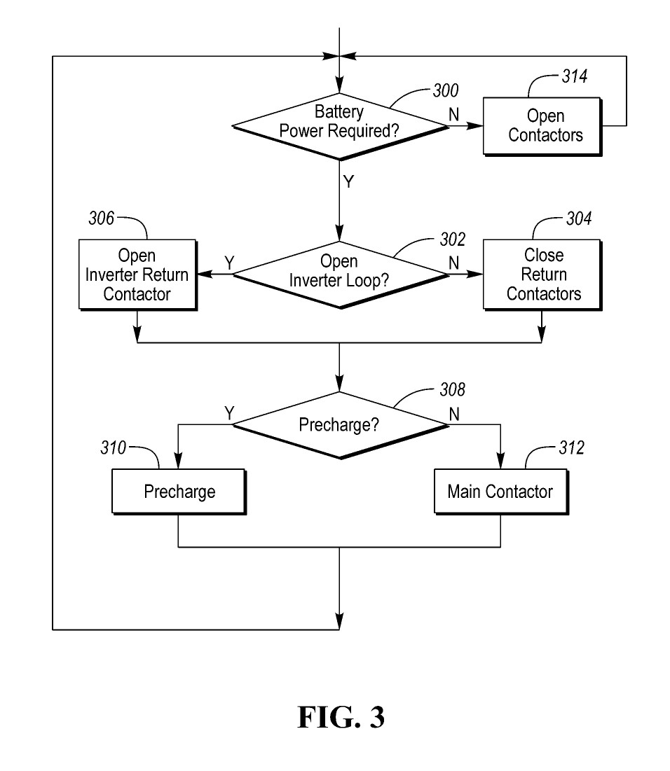

FIG. 3 depicts a flow chart of a sequence of operations that may be implemented in a controller (e.g., system controller 148). The controller 148 may be programmed to implement the operations. The sequence of operations may be implemented in the controller 148 and repeated at periodic intervals. At operation 300, conditions may be checked to determine if the high-voltage bus 152 should be connected to the traction battery 124. If there are no conditions indicating that the high-voltage bus 152 and the traction battery 124 should be connected, operation 314 may be performed. At operation 314, the pre-charge contactor 204, main contactor 206, inverter return contactor 208, and high-voltage return contactor 210 may be opened. Conditions for connecting the high-voltage bus 152 to the traction battery 124 may include the presence of an ignition-on signal. Conditions for connecting the high-voltage bus 152 to the traction battery 124 may include the insertion of the EVSE connector 140 into the charge port 134 and a demand for battery charging. For example, the vehicle may receive an ignition-on signal in response to a key being inserted in an ignition switch or a request from a remote start system. An ignition-off signal may be received in response to removal of the key. The ignition-off signal may indicate that the high-voltage bus 152 and the traction battery 124 should be disconnected.

If conditions are present for requesting connection of the high-voltage bus 152 and the traction battery 124, operation 302 may be performed. At operation 302, a check may be performed to determine if a circuit loop (referred to as inverter loop) that includes the power electronics module 126 and the high-voltage bus 152 should be opened. The controller 148 may monitor for a loss of switch control in the power electronics module 126. In the event a loss of the switch control, the inverter circuit loop may be isolated from the traction battery 124 while the circuit loop that includes the electrical load 146 and DC/DC converter 128 remains coupled to the traction battery 124. The loss of switch control may be detected when conditions are present in which the power electronics module 126 is unable to regulate the voltage provided to the high-voltage bus 152 from the electric machine 114. The inverter circuit loop may be opened if the traction battery voltage exceeds a predetermined voltage while the electric machine 114 is operating as a generator. The predetermined voltage may be a voltage value that is indicative of a loss of switch control in the power electronics module 126. The control strategy may check a speed of the electric machine 114 and an operating status of the power electronics module 126. If the loss of switch control is detected such that the voltage can exceed a predetermined limit, operation 306 may be performed. Another condition for opening the inverter loop may be receipt of a signal from the power electronics module 126 that is indicative of the switch control function of the power electronics module 126 being inoperative. Additionally, the inverter loop may be opened in response to detecting that the regenerative power generated by the electric machine 114 exceeds a predetermined regenerative power limit.

At operation 306, the inverter return contactor 208 may be opened to prevent current flow between the power electronics module 126 and the high-voltage bus 152. Opening the inverter return contactor 208 opens the circuit loop that includes the high-voltage bus 152 and the power electronics module 126. Opening the inverter circuit loop prevents the rotating electric machine 114 from increasing the voltage level of the high-voltage bus 152 to excessive levels. This eliminates the risk of subjecting other electrical components that are connected to the high-voltage bus 152 to the excessive voltage. During this time, the high-voltage return contactor 210 may be maintained in the previous operating condition. For example, the high-voltage return contactor 210 may be maintained in a closed state so that operation of the electrical load 146 and DC/DC converter module 128 may continue. As a further benefit, the high-voltage electrical components may be designed to withstand a rated voltage that is less than a maximum back EMF of the electric machine 114 which may lower cost and size of the electrical components. For example, a rated maximum inverter voltage is greater than a maximum regenerative voltage level of the electric machine 114, while a rated maximum voltage of the electrical load 146 may be less than a maximum regenerative voltage level. The maximum regenerative voltage level may be a voltage produced by the electric machine 114 through the power electronics module 126 at high electric machine speeds when there is loss of switch control.

If the inverter circuit loop is not requested to be opened (e.g., switch control is active or available), operation 304 may be performed. For example, if the switch control of the power electronics module 126 is operational, the current/power caused by the electric machine 114 can be controlled to a target level. At operation 304, the inverter return contactor 208 and the high-voltage return contactor 210 may be closed and/or maintained in a closed position.

After performing operations 304 or 306, operation 308 may be performed. At operation 308, a check for conditions indicative of a pre-charge operation in progress and/or a request for pre-charging the high-voltage bus 152 may be performed. A pre-charge operation may be performed when capacitive loads coupled to the high-voltage bus 152 have not been charged. For example, the power electronics module 126 may include a capacitor coupled across the terminals to smooth the voltage. The purpose of the pre-charge operation is to limit the large initial current flow that can occur when switching a voltage to a capacitive load. The pre-charge cycle may be performed when the traction battery 124 is decoupled from the high-voltage bus for longer than a predetermined time. The pre-charge cycle may be performed when the voltage of the high-voltage bus 152 is more than a predetermined amount less than the traction battery voltage. The pre-charge operation may be initiated when the previous state of the inverter return contactor was opened (e.g., transitioned from opened to closed). The pre-charge operation may be initiated upon vehicle power-up.

If a pre-charge cycle is requested and/or in progress, operation 310 may be performed. At operation 310, the pre-charge operation may be performed. During the pre-charge operation, the pre-charge contactor 204 may be closed to pre-charge capacitive elements that may be coupled to the high-voltage bus 152. During the pre-charge operation, current flow is limited by the pre-charge resistor 202. As part of initiating the pre-charge operation, the pre-charge contactor 204 may be closed and the main contactor 206 may be opened. During the pre-charge operation, the main contactor 206 may be opened or maintained in the open state and the pre-charge contactor 204 may be maintained in the closed state. The pre-charge operation may be completed when the difference between the traction battery voltage and the high-voltage bus voltage is less than a predetermined amount. The pre-charge operation may be completed after a predetermined time interval has expired from initiation of the pre-charge operation.

If the pre-charge operation is not requested or has been completed, operation 312 may be performed. For example, the pre-charge operation may be completed when the difference between the traction battery voltage and the high-voltage bus voltage is less than a predetermined amount. At operation 312, the main contactor 206 may be closed and the pre-charge contactor 204 may be opened. At this time, the high-voltage bus 152 is ready for vehicle operation. The main contactor 206 may be maintained in the closed state and the pre-charge contactor 204 may be maintained in the open state. Upon completion of operations 310 or 312, execution may return to operation 300 to repeat the cycle.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a first contactor selectively coupling a traction battery and an inverter that operates an electric machine via switch control;
a second contactor selectively coupling an electrical load and the traction battery, the first contactor and the second contactor being closed during the switch control; and
a controller programmed to, in response to loss of the switch control, open the first contactor but not the second contactor to isolate the inverter.

2. The vehicle of claim 1 wherein the controller is further programmed to detect loss of the switch control in response to a voltage of a low-voltage power source to the inverter being less than a predetermined threshold.

3. The vehicle of claim 1 wherein the controller is further programmed to detect loss of the switch control in response to high-voltage bus voltage exceeding a predetermined voltage while the electric machine is operating as a generator.

4. The vehicle of claim 1 wherein the first contactor is connected between an inverter return terminal and a traction battery return terminal.

5. The vehicle of claim 1 wherein the second contactor is connected between an electrical load return terminal and a traction battery return terminal.

6. The vehicle of claim 1 wherein the controller is further programmed to, in response to the switch control being restored after the loss of the switch control, close the first contactor.

7. The vehicle of claim 1 wherein the controller is further programmed to, in response to the switch control being restored after the loss of the switch control, close a pre-charge contactor coupled between the traction battery and the inverter to limit current flow between the inverter and the traction battery and, after a predetermined time, close the first contactor.

8. The vehicle of claim 1 wherein a rated maximum voltage of the electrical load is less than a maximum regenerative voltage level of the electric machine and a rated maximum inverter voltage is greater than or equal to the maximum regenerative voltage level of the electric machine.

9. A power distribution system for a vehicle comprising:
a first contactor selectively coupling a traction battery and an inverter that operates an electric machine via switch control;
a second contactor selectively coupling an electrical load and the traction battery; and
a controller programmed to, in response to loss of the switch control, open the first contactor but not the second contactor to isolate the inverter.

10. The power distribution system of claim 9 wherein the controller is further programmed to detect loss of the switch control when a voltage of a low-voltage power source powering the inverter is less than a predetermined threshold.

11. The power distribution system of claim 9 wherein the controller is further programmed to detect loss of the switch control in response to a signal from the inverter indicative of the inverter being inoperative.

12. The power distribution system of claim 9 wherein the controller is further programmed to detect loss of the switch control in response to a traction battery voltage exceeding a predetermined voltage while the electric machine is operating as a generator.

13. The power distribution system of claim 9 wherein the controller is further programmed to, in response to the switch control being restored after the loss of the switch control, close the first contactor to connect the inverter to the traction battery.

14. The power distribution system of claim 9 wherein the controller is further programmed to, in response to the switch control being restored after the loss of the switch control, close a pre-charge contactor coupled between the traction battery and the inverter to limit current flow between the inverter and the traction battery.

15. The power distribution system of claim 9 wherein the controller is further programmed to detect loss of the switch control in response to a temperature of the inverter exceeding a predetermined temperature.

16. A method comprising:
closing, by a controller, a first contactor coupling a traction battery to an inverter that controls an electric machine via switch control and a second contactor coupling the traction battery to an electrical load for operating a vehicle;
opening, by the controller, the first contactor in response to loss of the switch control; and
maintaining, by the controller, the second contactor as closed during loss of the switch control.

17. The method of claim 16 further comprising opening, by the controller, the first contactor in response to a traction battery voltage exceeding a predetermined voltage while the electric machine is operating as a generator while maintaining the second contactor as closed.

18. The method of claim 16 further comprising closing the first contactor, by the controller, in response to restoration of the switch control.

19. The method of claim 18 further comprising closing, by the controller, a pre-charge contactor coupled between the traction battery and a voltage bus coupled to the electric machine and the electrical load and closing the first contactor in response to restoration of the switch control.

20. The method of claim 16 further comprising maintaining, by the controller, a main contactor that couples the traction battery to a voltage bus that is coupled to the inverter and the electrical load in a closed state while the first contactor is opened.
